(19) United States
(12) Patent Application Publication
(10) Pub. No.: US 2018/0224860 A1
(43) Pub. Date: Aug. 9, 2018

(54) AUTONOMOUS VEHICLE MOVEMENT AROUND STATIONARY VEHICLES

(71) Applicant: GM GLOBAL TECHNOLOGY OPERATIONS LLC, Detroit, MI (US)

(72) Inventors: GABRIEL WARSHAUER-BAKER, MOUNTAIN VIEW, CA (US); BENJAMIN WEINSTEIN-RAUN, SAN FRANCISCO, CA (US)

(73) Assignee: GM GLOBAL TECHNOLOGY OPERATIONS LLC, Detroit, MI (US)

(21) Appl. No.: 15/943,572

(22) Filed: Apr. 2, 2018

(51) Int. Cl. G05D 1/02; G05D 1/00; G08G 1/0962; G08G 1/16

(52) U.S. Cl. CPC G05D 1/0214; G05D 1/0088; G05D 2201/0213; G08G 1/165; G08G 1/09623

(57) ABSTRACT

In one embodiment, a method for controlling movement of an autonomous vehicle around a stationary vehicle includes obtaining data, via one or more sensors, pertaining to the stationary vehicle; making a plurality of initial determinations pertaining to the stationary vehicle, via a processor, based on the data; determining whether the stationary vehicle is double parked, via the processor, based on the plurality of initial determinations; and facilitating movement of the autonomous vehicle around the stationary vehicle, via instructions provided by the processor, if it is determined that the stationary vehicle is double parked.

### TECHNICAL FIELD

The present disclosure generally relates to vehicles, and more particularly relates to systems and methods for movement of autonomous vehicles.

### BACKGROUND

An autonomous vehicle is a vehicle that is capable of sensing its environment and navigating with little or no user input. It does so by using sensing devices such as radar, lidar, image sensors, and the like. Autonomous vehicles further use information from global positioning systems (GPS) technology, navigation systems, vehicle-to-vehicle communication, vehicle-to-infrastructure technology, and/or drive-by-wire systems to navigate the vehicle.

While autonomous vehicles offer many potential advantages over traditional vehicles, in certain circumstances it may be desirable for improved movement of autonomous vehicles, for example another stationary vehicle.

Accordingly, it is desirable to provide systems and methods for movement of autonomous vehicles.

### SUMMARY

Systems and methods are provided for controlling movement of an autonomous vehicle around a stationary vehicle. In one embodiment, a method for controlling movement of an autonomous vehicle around a stationary vehicle includes obtaining data, via one or more sensors, pertaining to the stationary vehicle; making a plurality of initial determinations pertaining to the stationary vehicle, via a processor, based on the data; determining whether the stationary vehicle is double parked, via the processor, based on the plurality of initial determinations; and facilitating movement of the autonomous vehicle around the stationary vehicle, via instructions provided by the processor, if it is determined that the stationary vehicle is double parked.

Also in one embodiment, the method further includes wherein the making of the plurality of initial determinations includes determining whether hazard lights for the stationary vehicle are turned on; and the determining of whether the stationary vehicle is double parked is based at least in part on whether the hazard lights are turned on

Also in one embodiment, the making of the plurality of initial determinations includes determining whether traffic in proximity to the stationary vehicle is moving at a speed that is greater than a predetermined threshold; and the determining of whether the stationary vehicle is double parked is based at least in part on whether the traffic is moving at a speed that is greater than the predetermined threshold

Also in one embodiment, the making of the plurality of initial determinations includes determining whether the stationary vehicle is stopped at a red light; and the determining of whether the stationary vehicle is double parked is based at least in part on whether the stationary vehicle is stopped at a red light.

Also in one embodiment, the making of the plurality of initial determinations includes determining whether the stationary vehicle is stopped at a stop sign; and the determining of whether the stationary vehicle is double parked is based at least in part on whether the stationary vehicle is stopped at a stop sign.

Also in one embodiment, the making of the plurality of initial determinations includes determining whether the stationary vehicle is disposed behind another vehicle; and the determining of whether the stationary vehicle is double parked is based at least in part on whether the stationary vehicle is disposed behind another vehicle

Also in one embodiment, the making of the plurality of initial determinations includes determining whether the stationary vehicle has recently moved within a predetermined amount of time; and the determining of whether the stationary vehicle is double parked is based at least in part on whether the stationary vehicle has moved within the predetermined amount of time.

Also in one embodiment, the making of the plurality of initial determinations includes: determining whether hazard lights for the stationary vehicle are turned on; and determining whether traffic in proximity to the stationary vehicle is moving at a speed that is greater than a predetermined threshold; and the determining of whether the stationary vehicle is double parked includes determining that the stationary vehicle is double parked if the hazard lights are on, the traffic is moving at a speed that is greater than the predetermined threshold, or both.

Also in one embodiment, the making of the plurality of initial determinations includes: determining whether the stationary vehicle is stopped at a red light; determining whether the stationary vehicle is stopped at a stop sign; and determining whether the stationary vehicle is disposed behind another vehicle; and the determining of whether the stationary vehicle is double parked includes determining that the stationary vehicle is not double parked if any one or more of the following criteria are satisfied, namely: that the stationary vehicle is stopped at a red light, the stationary vehicle is stopped at a stop sign, or the stationary vehicle is stopped behind another vehicle.

Also in one embodiment, the stationary vehicle is determined to be double parked if the stationary vehicle has not moved within the predetermined amount of time; and the stationary vehicle is determined to be double parked if the stationary vehicle has not moved within the predetermined amount of time.

In another embodiment, a system for controlling movement of an autonomous vehicle around a stationary vehicle includes a double park object module and a double park determination module. The double park object module is configured to at least facilitate obtaining data pertaining to the stationary vehicle. The double park determination module includes a processor, and is configured to at least facilitate making a plurality of initial determinations pertaining to the stationary vehicle, based on the data; determining whether the stationary vehicle is double parked, based on the plurality of initial determinations; and facilitating movement of the autonomous vehicle around the stationary vehicle, if it is determined that the stationary vehicle is double parked.

Also in one embodiment, the double park determination module is configured to at least facilitate determining whether hazard lights for the stationary vehicle are turned on; and determining whether the stationary vehicle is double parked based at least in part on whether the hazard lights are turned on.

Also in one embodiment, the double park determination module is configured to at least facilitate determining whether traffic in proximity to the stationary vehicle is moving at a speed that is greater than a predetermined threshold; and determining whether the stationary vehicle is double parked based at least in part on whether the traffic is moving at a speed that is greater than the predetermined threshold.

Also in one embodiment, the double park determination module is configured to at least facilitate determining whether the stationary vehicle is stopped at a red light; and determining whether the stationary vehicle is double parked based at least in part on whether the stationary vehicle is stopped at a red light.

Also in one embodiment, the double park determination module is configured to at least facilitate determining whether the stationary vehicle is stopped at a stop sign; and determining whether the stationary vehicle is double parked based at least in part on whether the stationary vehicle is stopped at a stop sign.

Also in one embodiment, the double park determination module is configured to at least facilitate determining whether the stationary vehicle is stopped at a stop sign; and determining whether the stationary vehicle is double parked based at least in part on whether the stationary vehicle is stopped at a stop sign.

Also in one embodiment, the double park determination module is configured to at least facilitate determining whether the stationary vehicle has recently moved within a predetermined amount of time; and determining whether the stationary vehicle is double parked based at least in part on whether the stationary vehicle has moved within the predetermined amount of time.

Also in one embodiment, the double park determination module is configured to at least facilitate determining whether hazard lights for the stationary vehicle are turned on; determining whether traffic in proximity to the stationary vehicle is moving at a speed that is greater than a predetermined threshold; and determining that the stationary vehicle is double parked if the hazard lights are on, the traffic is moving at a speed that is greater than the predetermined threshold, or both.

Also in one embodiment, the double park determination module is configured to at least facilitate determining whether the stationary vehicle is stopped at a red light; determining whether the stationary vehicle is stopped at a stop sign; determining whether the stationary vehicle is disposed behind another vehicle; and determining that the stationary vehicle is not double parked if any one or more of the following criteria are satisfied, namely: that the stationary vehicle is stopped at a red light, the stationary vehicle is stopped at a stop sign, or the stationary vehicle is stopped behind another vehicle.

In another exemplary embodiment, an autonomous vehicle includes a plurality of sensors, a steering system, and a processor. The plurality of sensors are configured to at least facilitate obtaining data pertaining to a stationary vehicle that is disposed in proximity to the autonomous vehicle. The processor that is configured to at least facilitate making a plurality of initial determinations pertaining to the stationary vehicle, based on the data; determining whether the stationary vehicle is double parked, based on the plurality of initial determinations; and facilitating movement of the autonomous vehicle around the stationary vehicle, via instructions provided from the processor to the steering system, if it is determined that the stationary vehicle is double parked.

### DESCRIPTION OF THE DRAWINGS

The exemplary embodiments will hereinafter be described in conjunction with the following drawing figures, wherein like numerals denote like elements, and wherein:

FIG. 1 is a functional block diagram illustrating an autonomous vehicle, in accordance with various embodiments;

FIG. 2 is a functional block diagram illustrating a transportation system having one or more autonomous vehicles as shown in FIG. 1, in accordance with various embodiments;

FIG. 3 is functional block diagram illustrating an autonomous driving system (ADS) associated with an autonomous vehicle, in accordance with various embodiments;

FIG. 4 is a dataflow diagram illustrating a double park maneuver control system for autonomous vehicles, in accordance with various embodiments;

FIG. 5 is a schematic diagram of an autonomous vehicle on a roadway in proximity to stationary vehicle, in accordance with various embodiments; and

FIG. 6 is a flowchart for a control process for maneuvering around a stationary vehicle, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary, or the following detailed description. As used herein, the term “module” refers to any hardware, software, firmware, electronic control component, processing logic, and/or processor device, individually or in any combination, including without limitation: application specific integrated circuit (ASIC), a field-programmable gate-array (FPGA), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, machine learning, image analysis, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

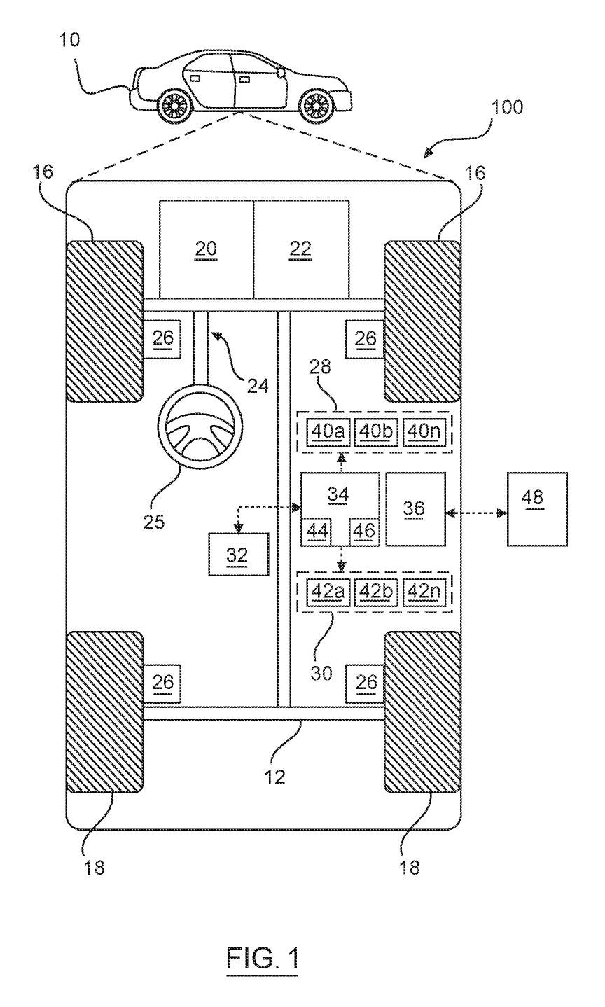

With reference to FIG. 1, a double park maneuver control system 100 shown generally as 100 is associated with a vehicle 10 in accordance with various embodiments. In general, the double park maneuver control system (or simply “system”) 100 controls maneuvers of the vehicle 10 around nearby stationary vehicles.

As depicted in FIG. 1, the vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14.

In various embodiments, the vehicle 10 is an autonomous vehicle and the double park maneuver control system 100, and/or components thereof, are incorporated into the autonomous vehicle 10 (hereinafter referred to as the autonomous vehicle 10). The autonomous vehicle 10 is, for example, a vehicle that is automatically controlled to carry passengers from one location to another. The vehicle 10 is depicted in the illustrated embodiment as a passenger car, but it should be appreciated that any other vehicle, including motorcycles, trucks, sport utility vehicles (SUVs), recreational vehicles (RVs), marine vessels, aircraft, and the like, can also be used.

In an exemplary embodiment, the autonomous vehicle 10 corresponds to a level four or level five automation system under the Society of Automotive Engineers (SAE) “J3016” standard taxonomy of automated driving levels. Using this terminology, a level four system indicates “high automation,” referring to a driving mode in which the automated driving system performs all aspects of the dynamic driving task, even if a human driver does not respond appropriately to a request to intervene. A level five system, on the other hand, indicates “full automation,” referring to a driving mode in which the automated driving system performs all aspects of the dynamic driving task under all roadway and environmental conditions that can be managed by a human driver. It will be appreciated, however, the embodiments in accordance with the present subject matter are not limited to any particular taxonomy or rubric of automation categories. Furthermore, systems in accordance with the present embodiment may be used in conjunction with any autonomous or other vehicle that utilizes a navigation system and/or other systems to provide route guidance and/or implementation.

As shown, the autonomous vehicle 10 generally includes a propulsion system 20, a transmission system 22, a steering system 24, a brake system 26, a sensor system 28, an actuator system 30, at least one data storage device 32, at least one controller 34, and a communication system 36. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16 and 18 according to selectable speed ratios. According to various embodiments, the transmission system 22 may include a step-ratio automatic transmission, a continuously-variable transmission, or other appropriate transmission.

The brake system 26 is configured to provide braking torque to the vehicle wheels 16 and 18. Brake system 26 may, in various embodiments, include friction brakes, brake by wire, a regenerative braking system such as an electric machine, and/or other appropriate braking systems.

The steering system 24 influences a position of the vehicle wheels 16 and/or 18. While depicted as including a steering wheel 25 for illustrative purposes, in some embodiments contemplated within the scope of the present disclosure, the steering system 24 may not include a steering wheel.

The sensor system 28 includes one or more sensing devices 40a-40n that sense observable conditions of the exterior environment and/or the interior environment of the autonomous vehicle 10. The sensing devices 40a-40n might include, but are not limited to, radars, lidars, global positioning systems, optical cameras, thermal cameras, ultrasonic sensors, and/or other sensors. The actuator system 30 includes one or more actuator devices 42a-42n that control one or more vehicle features of the vehicle 10. In various embodiments, the actuator devices 42a-42n In addition, in various embodiments, the actuator devices 42a-42n (also referred to as the actuators 42) control one or more features such as, but not limited to, the propulsion system 20, the transmission system 22, the steering system 24, the brake system 26, and actuators for opening and closing the doors of the vehicle 10. In various embodiments, autonomous vehicle 10 may also include interior and/or exterior vehicle features not illustrated in FIG. 1, such as a trunk, and cabin features such as air, music, lighting, touch-screen display components (such as those used in connection with navigation systems), and the like.

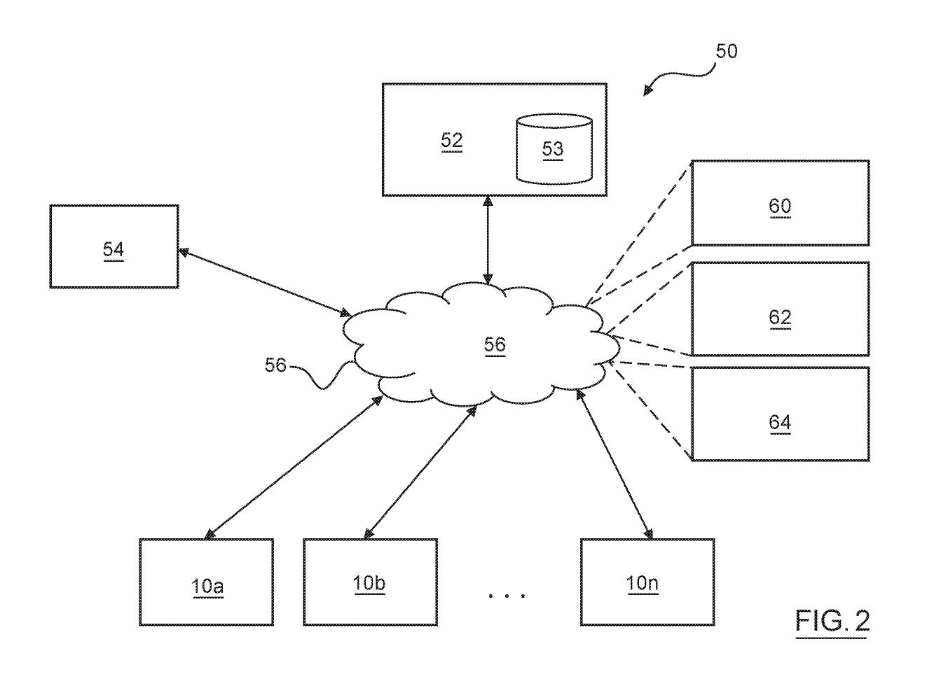

The data storage device 32 stores data for use in automatically controlling the autonomous vehicle 10. In various embodiments, the data storage device 32 stores defined maps of the navigable environment. In various embodiments, the defined maps may be predefined by and obtained from a remote system (described in further detail with regard to FIG. 2). For example, the defined maps may be assembled by the remote system and communicated to the autonomous vehicle 10 (wirelessly and/or in a wired manner) and stored in the data storage device 32. Route information may also be stored within data device 32—i.e., a set of road segments (associated geographically with one or more of the defined maps) that together define a route that the user may take to travel from a start location (e.g., the user's current location) to a target location. Also in various embodiments, the data storage device 32 stores data pertaining to roadways on which the vehicle 10 may be travelling. As will be appreciated, the data storage device 32 may be part of the controller 34, separate from the controller 34, or part of the controller 34 and part of a separate system.

The controller 34 includes at least one processor 44 and a computer-readable storage device or media 46. The processor 44 may be any custom-made or commercially available processor, a central processing unit (CPU), a graphics processing unit (GPU), an auxiliary processor among several processors associated with the controller 34, a semiconductor-based microprocessor (in the form of a microchip or chip set), any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the autonomous vehicle 10.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the autonomous vehicle 10, and generate control signals that are transmitted to the actuator system 30 to automatically control the components of the autonomous vehicle 10 based on the logic, calculations, methods, and/or algorithms. Although only one controller 34 is shown in FIG. 1, embodiments of the autonomous vehicle 10 may include any number of controllers 34 that communicate over any suitable communication medium or a combination of communication mediums and that cooperate to process the sensor signals, perform logic, calculations, methods, and/or algorithms, and generate control signals to automatically control features of the autonomous vehicle 10. In one embodiment, as discussed in detail below, controller 34 is configured for use in controlling maneuvers for the vehicle 10 around stationary vehicles.

The communication system 36 is configured to wirelessly communicate information to and from other entities 48, such as but not limited to, other vehicles (“V2V” communication), infrastructure (“V2I” communication), remote transportation systems, and/or user devices (described in more detail with regard to FIG. 2). In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

With reference now to FIG. 2, in various embodiments, the autonomous vehicle 10 described with regard to FIG. 1 may be suitable for use in the context of a taxi or shuttle system in a certain geographical area (e.g., a city, a school or business campus, a shopping center, an amusement park, an event center, or the like) or may simply be managed by a remote system. For example, the autonomous vehicle 10 may be associated with an autonomous vehicle based remote transportation system. FIG. 2 illustrates an exemplary embodiment of an operating environment shown generally at 50 that includes an autonomous vehicle based remote transportation system (or simply “remote transportation system”) 52 that is associated with one or more autonomous vehicles 10a-10n as described with regard to FIG. 1. In various embodiments, the operating environment 50 (all or a part of which may correspond to entities 48 shown in FIG. 1) further includes one or more user devices 54 that communicate with the autonomous vehicle 10 and/or the remote transportation system 52 via a communication network 56.

The communication network 56 supports communication as needed between devices, systems, and components supported by the operating environment 50 (e.g., via tangible communication links and/or wireless communication links). For example, the communication network 56 may include a wireless carrier system 60 such as a cellular telephone system that includes a plurality of cell towers (not shown), one or more mobile switching centers (MSCs) (not shown), as well as any other networking components required to connect the wireless carrier system 60 with a land communications system. Each cell tower includes sending and receiving antennas and a base station, with the base stations from different cell towers being connected to the MSC either directly or via intermediary equipment such as a base station controller. The wireless carrier system 60 can implement any suitable communications technology, including for example, digital technologies such as CDMA (e.g., CDMA2000), LTE (e.g., 4G LTE or 5G LTE), GSM/GPRS, or other current or emerging wireless technologies. Other cell tower/base station/MSC arrangements are possible and could be used with the wireless carrier system 60. For example, the base station and cell tower could be co-located at the same site or they could be remotely located from one another, each base station could be responsible for a single cell tower or a single base station could service various cell towers, or various base stations could be coupled to a single MSC, to name but a few of the possible arrangements.

Apart from including the wireless carrier system 60, a second wireless carrier system in the form of a satellite communication system 64 can be included to provide uni-directional or bi-directional communication with the autonomous vehicles 10a-10n. This can be done using one or more communication satellites (not shown) and an uplink transmitting station (not shown). Uni-directional communication can include, for example, satellite radio services, wherein programming content (news, music, and the like) is received by the transmitting station, packaged for upload, and then sent to the satellite, which broadcasts the programming to subscribers. Bi-directional communication can include, for example, satellite telephony services using the satellite to relay telephone communications between the vehicle 10 and the station. The satellite telephony can be utilized either in addition to or in lieu of the wireless carrier system 60.

A land communication system 62 may further be included that is a conventional land-based telecommunications network connected to one or more landline telephones and connects the wireless carrier system 60 to the remote transportation system 52. For example, the land communication system 62 may include a public switched telephone network (PSTN) such as that used to provide hardwired telephony, packet-switched data communications, and the Internet infrastructure. One or more segments of the land communication system 62 can be implemented through the use of a standard wired network, a fiber or other optical network, a cable network, power lines, other wireless networks such as wireless local area networks (WLANs), or networks providing broadband wireless access (BWA), or any combination thereof. Furthermore, the remote transportation system 52 need not be connected via the land communication system 62, but can include wireless telephony equipment so that it can communicate directly with a wireless network, such as the wireless carrier system 60.

Although only one user device 54 is shown in FIG. 2, embodiments of the operating environment 50 can support any number of user devices 54, including multiple user devices 54 owned, operated, or otherwise used by one person. Each user device 54 supported by the operating environment 50 may be implemented using any suitable hardware platform. In this regard, the user device 54 can be realized in any common form factor including, but not limited to: a desktop computer; a mobile computer (e.g., a tablet computer, a laptop computer, or a netbook computer); a smartphone; a video game device; a digital media player; a component of a home entertainment equipment; a digital camera or video camera; a wearable computing device (e.g., smart watch, smart glasses, smart clothing); or the like. Each user device 54 supported by the operating environment 50 is realized as a computer-implemented or computer-based device having the hardware, software, firmware, and/or processing logic needed to carry out the various techniques and methodologies described herein. For example, the user device 54 includes a microprocessor in the form of a programmable device that includes one or more instructions stored in an internal memory structure and applied to receive binary input to create binary output. In some embodiments, the user device 54 includes a GPS module capable of receiving GPS satellite signals and generating GPS coordinates based on those signals. In other embodiments, the user device 54 includes cellular communications functionality such that the device carries out voice and/or data communications over the communication network 56 using one or more cellular communications protocols, as are discussed herein. In various embodiments, the user device 54 includes a visual display, such as a touch-screen graphical display, or other display.

The remote transportation system 52 includes one or more backend server systems, not shown), which may be cloud-based, network-based, or resident at the particular campus or geographical location serviced by the remote transportation system 52. The remote transportation system 52 can be manned by a live advisor, an automated advisor, an artificial intelligence system, or a combination thereof. The remote transportation system 52 can communicate with the user devices 54 and the autonomous vehicles 10a-10n to schedule rides, dispatch autonomous vehicles 10a-10n, and the like. In various embodiments, the remote transportation system 52 stores store account information such as subscriber authentication information, vehicle identifiers, profile records, biometric data, behavioral patterns, and other pertinent subscriber information. In one embodiment, as described in further detail below, remote transportation system 52 includes a route database 53 that stores information relating to navigational system routes, including lane markings for roadways along the various routes, and whether and to what extent particular route segments are impacted by construction zones or other possible hazards or impediments that have been detected by one or more of autonomous vehicles 10a-10n.

In accordance with a typical use case workflow, a registered user of the remote transportation system 52 can create a ride request via the user device 54. The ride request will typically indicate the passenger's desired pickup location (or current GPS location), the desired destination location (which may identify a predefined vehicle stop and/or a user-specified passenger destination), and a pickup time. The remote transportation system 52 receives the ride request, processes the request, and dispatches a selected one of the autonomous vehicles 10a-10n (when and if one is available) to pick up the passenger at the designated pickup location and at the appropriate time. The transportation system 52 can also generate and send a suitably configured confirmation message or notification to the user device 54, to let the passenger know that a vehicle is on the way.

As can be appreciated, the subject matter disclosed herein provides certain enhanced features and functionality to what may be considered as a standard or baseline autonomous vehicle 10 and/or an autonomous vehicle based remote transportation system 52. To this end, an autonomous vehicle and autonomous vehicle based remote transportation system can be modified, enhanced, or otherwise supplemented to provide the additional features described in more detail below.

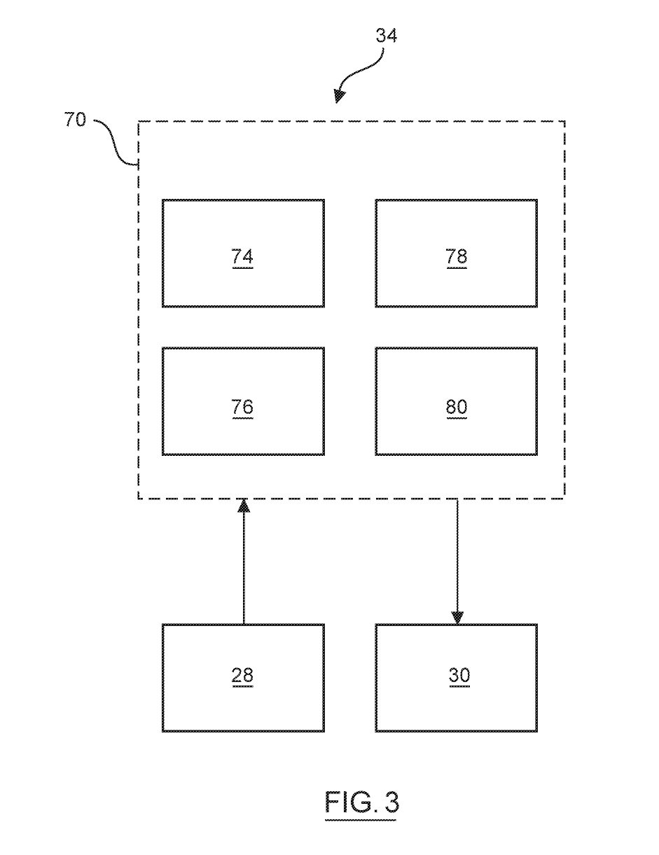

In accordance with various embodiments, controller 34 implements an autonomous driving system (ADS) as shown in FIG. 3. That is, suitable software and/or hardware components of controller 34 (e.g., processor 44 and computer-readable storage device 46) are utilized to provide an ADS that is used in conjunction with vehicle 10.

In various embodiments, the instructions of the autonomous driving system 70 may be organized by function or system. For example, as shown in FIG. 3, the autonomous driving system 70 can include a sensor fusion system 74, a positioning system 76, a guidance system 78, and a vehicle control system 80. As can be appreciated, in various embodiments, the instructions may be organized into any number of systems (e.g., combined, further partitioned, etc.) as the disclosure is not limited to the present examples.

In various embodiments, the sensor fusion system 74 synthesizes and processes sensor data and predicts the presence, location, classification, and/or path of objects and features of the environment of the vehicle 10. In various embodiments, the sensor fusion system 74 can incorporate information from multiple sensors, including but not limited to cameras, lidars, radars, and/or any number of other types of sensors.

The positioning system 76 processes sensor data along with other data to determine a position (e.g., a local position relative to a map, an exact position relative to lane of a road, vehicle heading, velocity, etc.) of the vehicle 10 relative to the environment. The guidance system 78 processes sensor data along with other data to determine a path for the vehicle 10 to follow. The vehicle control system 80 generates control signals for controlling the vehicle 10 according to the determined path.

In various embodiments, the controller 34 implements machine learning techniques to assist the functionality of the controller 34, such as feature detection/classification, obstruction mitigation, route traversal, mapping, sensor integration, ground-truth determination, and the like.

With reference back to FIG. 1, in various embodiments, one or more instructions of the controller 34 are embodied in the user double park maneuver control system 100 of FIG. 1, which controls selection of a parking location for the vehicle 10.

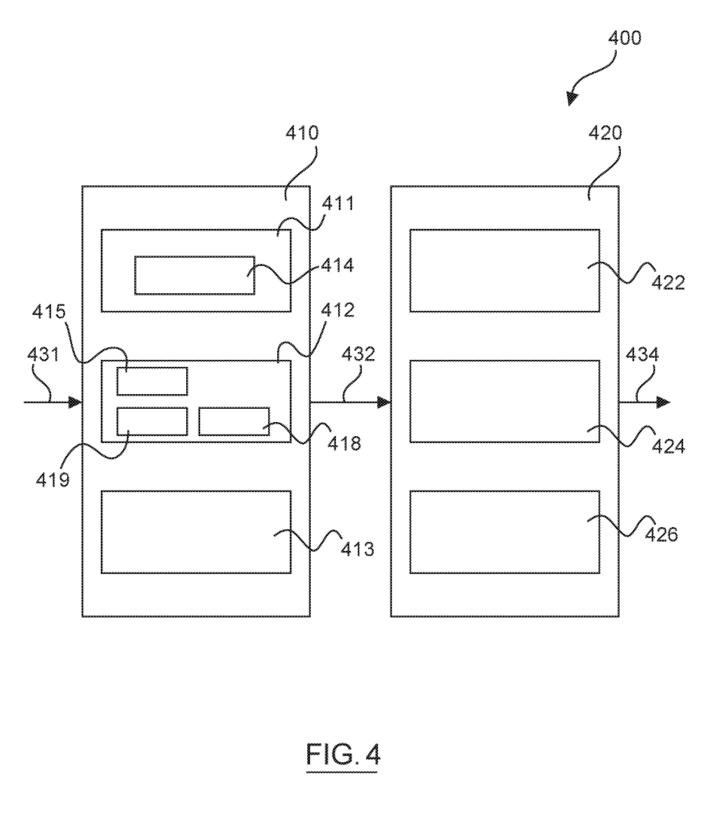

Referring to FIG. 4, an exemplary double park maneuver control system 400 generally includes a double park object module 410 and a double park determination module 420. In various embodiments, the double park object module 410 is disposed onboard the vehicle 10, for example as part of the sensor system 20 of FIG. 1. Also in the depicted embodiment, the double park object module 410 includes an interface 411, sensors 412, and a transceiver 413.

In various embodiments, the interface 411 includes an input device 414. The input device 414 receives inputs from a user (e.g., an occupant) of the vehicle 10. In certain embodiments, the user inputs include inputs as to a desired destination for the current vehicle ride. In certain embodiments, the input device 414 may include one or more touch screens, knobs, buttons, microphones, and/or other devices.

The sensors 412 provide sensor data pertaining to the vehicle 10, the current ride for the vehicle 10, the roadway and surroundings in proximity to the vehicle 10, including any stationary vehicles that may be disposed in proximity to the vehicle 10, and circumstances pertaining to such stationary vehicles. In various embodiments, the sensors 412 include one or more cameras 415, lidar sensors 417, and/or other sensors 418 (e.g. transmission sensors, wheel speed sensors, accelerometers, and/or other types of sensors).

In addition, in various embodiments, the transceiver 413 communicates with the double park determination module 420, for example via one or more wired and/or wireless connections, such as the communication network 56 of FIG. 2. Also in various embodiments, the transceiver 413 also communicates with one or more sources of information that are remote from the vehicle 10 (such as one or more global positioning system (GPS) satellites, remote services, and/or other remote data sources, for example as to traffic flows, and so on), for example via one or more wireless connections, such as the communication network 56 of FIG. 2. In addition, in certain embodiments, the transceiver 413 also receives inputs from the user (such as a requested destination for the vehicle 10), for example from the user device 54 of FIG. 2 (e.g., via one or more wired or wireless connections, such as the communication network 56 of FIG. 2).

In various embodiments, the double park determination module 420 is also disposed onboard the vehicle 10, for example as part of the controller 34 of FIG. 1. Also in the depicted embodiment, the double park determination module 420 includes a processor 422, a memory 424, and a transceiver 426.

In various embodiments, the processor 422 makes various determinations and provides control for the vehicle 10, including the steering system 24 of FIG. 1, and including the maneuvering of the vehicle 10 around certain nearby stationary vehicles that may be double parked. Also in various embodiments, the processor 422 of FIG. 4 corresponds to the processor 44 of FIG. 1.

In various embodiments, the memory 424 stores various types of information for use by the processor 422 in controlling the vehicle 10, including the maneuvering of the vehicle 10 around nearby stationary vehicles that may be double parked. For example, in certain embodiments, the memory 424 stores data pertaining to traffic flows, traffic light patterns or locations, stop sign locations, and/or a recent history of movement of the stationary vehicle, in addition to characteristics regarding nearby roadways and/or other types of information. Also in various embodiments, the memory 424 is part of the data storage device 32 of FIG. 1. In various embodiments, the transceiver 426 communicates with the double park object module 410, for example via one or more wired and/or wireless connections, such as the communication network 56 of FIG. 2. Also in various embodiments, the transceiver 426 also facilitates the transmission of instructions from the processor 422 to the parking location object module 410, such as via the communication network 56 of FIG. 2.

With further reference to FIG. 4, in various embodiments inputs 431 are provided to the double park object module 410. In various embodiments, the inputs 431 comprise for the double park object module 410 comprise data from one or more remote data sources (e.g., GPS satellites for location information and/or remote servers with information regarding recent traffic patterns, traffic light histories, recent movement of nearby stationary vehicles, and the like), for example as received via the transceiver 413.

Also with further reference to FIG. 4, in various embodiments the double park object module 410 provides outputs 432 that serve as inputs for the double park determination module 420. In various embodiments, the outputs 432 of the double park object module 410 (or, the inputs for the double park determination module 420) comprise information used by the double park determination module 420 for use in determining whether a nearby stationary vehicle is double parked, so that the vehicle 10 may maneuver around the stationary vehicle as appropriate if the stationary vehicle is double parked, and so on. For example, in various embodiments, the outputs 432 comprise sensor data obtained from the various sensors 412 (e.g. camera data, lidar data, and other data pertaining to the operation of the vehicle 10, the stationary vehicle(s) in proximity to the vehicle 10, traffic patterns and traffic light histories, and so on), as well as information pertaining to the above-described third party data sources (e.g., GPS satellites and/or remote servers and/or other data services with information regarding traffic flows, traffic light histories, and/or other data pertaining to the vehicle 10, its surroundings, and/or the nearby stationary vehicles). Also in certain embodiments, the outputs 432 are provided from the transceiver 413 of the double park object module 410 to the double park determination module 420 (e.g., via a wired or wireless connection).

Also as depicted in FIG. 4, in various embodiments the double park determination module 420 provides outputs 434. In various embodiments, the outputs 434 of the double park determination module 420 comprise instructions from the processor 422 to one or more vehicle systems (e.g., the steering system 24 of FIG. 1) for maneuvering of the vehicle 10 around a double parked stationary vehicle when appropriate.

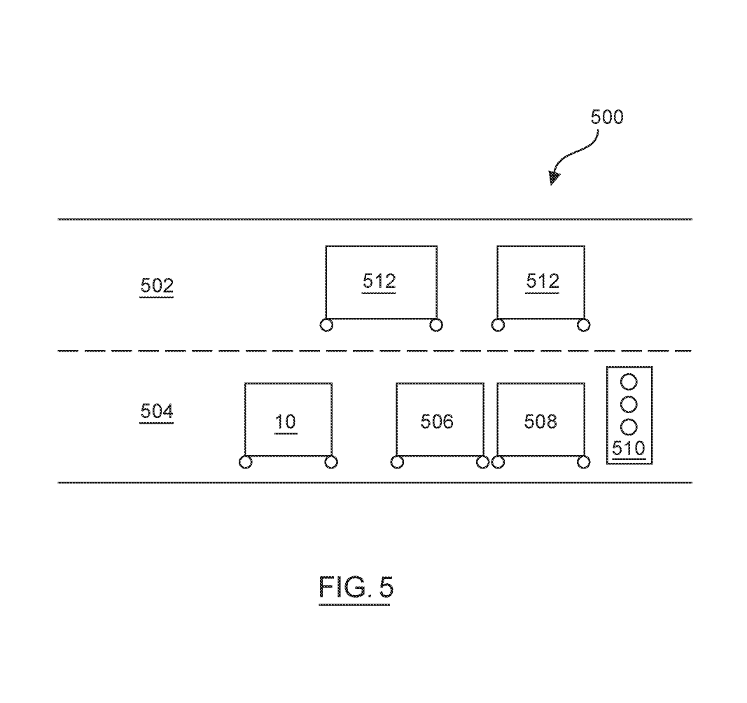

Turning now to FIG. 5, a schematic diagram is provided of the autonomous vehicle 10 in a particular environment, in accordance with various embodiments. As depicted in FIG. 5, in various embodiments the vehicle 10 is operating during a current vehicle ride along a roadway 500. In the depicted example, the roadway 500 includes two lanes 502, 504, with the vehicle 10 currently operating in current lane 504. Also as depicted in FIG. 5, a second vehicle (e.g., a stationary vehicle) 506 is disposed in front of the vehicle 10. Also as depicted in FIG. 5, in certain embodiments, one or more other objects, such as a third vehicle 508 and/or a traffic light 510, among other possible objects, are disposed in front of the second vehicle 506. Also various obstacles (e.g., other vehicle and/or other objects) 510 in proximity to the vehicle 10 are detected and monitored. In addition, also as shown in FIG. 5, various additional vehicles 512 may be moving as part of a traffic flow, for example in adjacent lane 502.

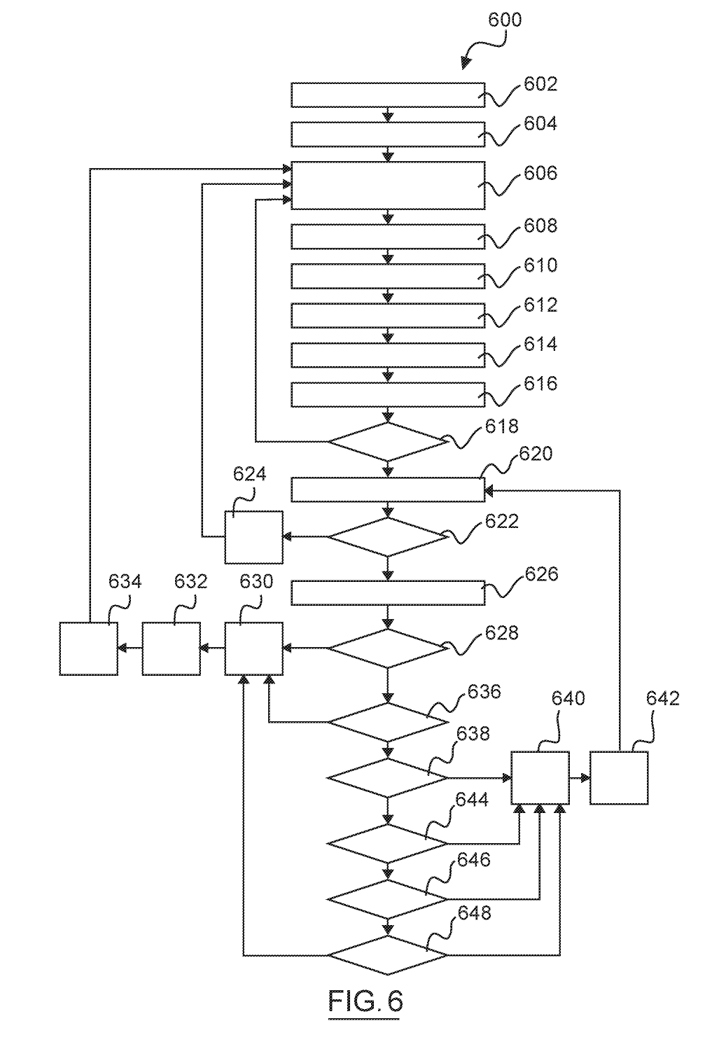

As will be set forth in greater detail below with respect to the control method 600 of FIG. 6, in various embodiments the vehicle 10 may or may not maneuver around the second vehicle 506, for example, depending upon whether the second vehicle 506 is double parked, among other possible considerations. In addition, also as discussed further below in connection with the control method 600 of FIG. 6, in various embodiment multiple different determinations are utilized in assessing whether the second vehicle 506 is double parked.

Referring now to FIG. 6, a flowchart is provided for a control method 600 for maneuvering an autonomous vehicle around a double parked stationary vehicle, in accordance with various embodiments. The control method 600 is discussed below in connection with FIG. 6 as well as continued reference to FIGS. 1-5. In various embodiments, the control method 600 can be performed by the system 100 and the associated implementations of FIGS. 1-5, in accordance with exemplary embodiments. As can be appreciated in light of the disclosure, the order of operation within the method is not limited to the sequential execution as illustrated in FIG. 6, but may be performed in one or more varying orders as applicable and in accordance with the present disclosure. In various embodiments, the control method 600 can be scheduled to run based on one or more predetermined events, and/or can run continuously during operation of the autonomous vehicle 10.

In various embodiments, the control method 600 may begin at 602. In various embodiments, 602 occurs when an occupant is within the vehicle 10 and the vehicle 10 begins operation in an automated manner.

Passenger inputs are obtained at 604. In various embodiments, the passenger inputs pertain to a desired destination for travel via the vehicle 10. In various embodiments, the user inputs may be obtained via the input device 414 of FIG. 4 and/or the user device 54 of FIG. 2 (e.g., via the transceiver 413 of FIG. 4).

Also in various embodiments, sensor data is obtained at 606. In various embodiments, data is obtained from the various sensors 412 of FIG. 4. For example, in various embodiments, camera data and lidar data are obtained and monitored from the cameras 415 and lidars 417, respectively, of FIG. 4. For example, in various embodiments, the camera and lidar data is used for detecting and monitoring the roadways and objects in proximity to the vehicle 10, including a stationary vehicle (target vehicle) 506 of FIG. 5 in front of the vehicle 10 as well as additional vehicles and other objects (e.g., corresponding to various objects 508, 510, and 512 of FIG. 5). Also in various embodiments, various other data is obtained via the other sensors 418 of FIG. 4 (e.g., further detection and tracking of objects using sonar, radar, and/or other sensors, obtaining measurements pertaining to the vehicle's speed and acceleration via wheel speeds sensors and accelerometers, and so on).

Map data is obtained at 608. In various embodiments, map data is retrieved from a memory, such as the memory 424 of FIG. 4 (e.g., corresponding to the data storage device 32 of FIG. 1, onboard the vehicle 10). In certain embodiments, the map data may be retrieved from the route database 53 of the autonomous vehicle based remote transportation system 52 of FIG. 2. Also in various embodiments, the map data comprises maps and associated data pertaining to roadways that are near the vehicle 10 and/or that are near or on the way from the vehicle 10's current to its destination (e.g., per the passenger inputs).

In various embodiments, other data is obtained at 610. In various embodiments, the other data is obtained at 610 via the transceiver 413 from or utilizing one or more remote data sources. By way of example, in certain embodiments, the other data of 610 may include GPS data using one or more GPS satellites, including the present location of the vehicle 10. By way of additional example, in certain embodiments, the other data of 610 may also include data regarding applicable traffic flows and patterns for the roadways, traffic light histories, histories of movement of nearby stationary vehicles, and/or weather, construction, and/or other data from one or more remote sources that may have an impact on parking location, route selection, and/or other operation of the vehicle 10, and/or one or more various other types of data.

A path for the autonomous vehicle is planned and implemented at 612. In various embodiments, the path is generated and implemented via the ADS 70 of FIG. 3 for the vehicle 10 of FIG. 1 to reach a requested destination (e.g., corresponding to the destination 505 of FIG. 5), using the passenger inputs of 604 and the map data of 608, for example via automated instructions provided by the processor 422. In various embodiments, the path of 612 comprises a path of movement of the vehicle 10 that would be expected to facilitate movement of the vehicle 10 to the intended destination while maximizing an associated score and/or desired criteria (e.g., minimizing driving time, maximizing safety and comfort, and so on). It will be appreciated that in various embodiments the path may also incorporate other data, for example such as the sensor data of 606 and/or the other data of 610. In various embodiments, the path for the vehicle 10 is planned and implemented using the processor 422 of FIG. 4.

A current location of the vehicle is determined at 614. In various embodiments, the current location is determined by the processor 422 using information obtained from 604, 608, 606 and/or 610. For example, in certain embodiments, the current location is determined using a GPS and/or other location system, and/or is received from such system. In certain other embodiments, the location may be determined using other sensor data from the vehicle (e.g. via user inputs provided via the input device 414 and/or received via the transceiver 413, camera data and/or sensor information combined with the map data, and so on).

An identification is made at 616 as to another vehicle that is disposed in proximity to the vehicle 10. In various embodiments, the processor 422 of FIG. 4 identifies such a vehicle (hereafter also referred to as a “target vehicle”, e.g., target vehicle 506 of FIG. 5) based on the sensor data of 606. In various embodiments, the determination of 616 is determined by the processor 422 of FIG. 4.

A determination is made at 618 as to whether the target vehicle of 616 is in front of the vehicle. In various embodiments, the processor 422 of FIG. 4 makes this determination based on the sensor data of 606. In certain embodiments, the target vehicle is determined to be in front of the vehicle 10 if the target vehicle is at least substantially directly in front of the vehicle 10. In certain other embodiments, the target vehicle is determined to be in front of the vehicle 10 if the target vehicle would block movement of the vehicle 10 if the vehicle 10 were to move straight ahead.

If it is determined in 618 that the target vehicle is not in front of the vehicle 10, then the process returns to 606. 606-618 thereafter repeat, in various iterations, until it is determined in an iteration of 618 that the target vehicle is in front of the vehicle 10.

Once it is determined in an iteration of 618 that the target vehicle is in front of the vehicle 10, the target vehicle continues to be monitored at 620. In various embodiments, the location, movement, and surroundings of the target vehicle are continually monitored by the processor 422 of FIG. 4 using continually updated sensor data of 608.

A determination is made at 622 as to whether the target vehicle is moving. In various embodiments, the determination of 622 is made by the processor 422 of FIG. 4 using continually updated sensor data of 608 and the monitoring of 620.

If it is determined at 622 that the target vehicle is moving, then one or more actions are taken at 624 with respect to the vehicle 10 and the target vehicle. In various embodiments, the processor 422 of FIG. 4 provides instructions to the steering system 24 of FIG. 1 for the vehicle 10 to follow the target vehicle in a leader/follower mode. The process then returns to 606. 606-622 thereafter repeat, in various iterations, until it is determined in an iteration of 622 that the target vehicle is not moving.

Once it is determined in an iteration of 622 that the target vehicle is not moving, then filtering is provided at 626 for the sensor data. In various embodiments, the processor 422 of FIG. 4 provides various levels of filtering of the sensor data of 606 for the continued monitoring of 620 and the subsequent determinations of 628-648, discussed below. For example, in certain embodiments, smoothing is provided for the sensor data. For example, in some embodiments, multiple distance readings (e.g., five readings, in one embodiment) are sequentially taken at different consecutive points in time with respect to the target vehicle and analyzed, for example for use in determining whether the target vehicle is moving, among other possible smoothing and/or other possible filtering techniques.

A determination is made at 628 as to whether hazard lights of the target vehicle have been turned on. In certain embodiments, this determination is made by the processor 422 of FIG. 4 based on the sensor data of 606 (e.g., from a camera 415 and/or lidar 417 of FIG. 4).

In one embodiment, if it is determined at 628 that the hazard lights are on, then it is determined at 630 that the target vehicle is double parked. In certain embodiments, this determination is made by the processor 422 of FIG. 4. In addition, instructions are provided at 632 for movement of the vehicle 10 around the target vehicle, and the instructions are implemented at 634 for maneuvering of the vehicle 10 around the target vehicle. In certain embodiments, the instructions are provided by the processor 422 of FIG. 4, and are implemented by the steering system 24 of FIG. 1. Also in certain embodiments, as part of the instructions, the processor 422 plans a path for the vehicle 10 to move around the target vehicle, and checks to make sure that the path is clear before implementation, among other possible checks to ensure smooth and successful maneuvering of the vehicle 10 around the target vehicle. The process then returns to 606, discussed above.

Conversely, if it is determined at 628 that the hazard lights are not on, then a determination is made at 636 as to whether nearby traffic is moving at a sufficient speed. In various embodiments, the processor 422 of FIG. 4 determines whether an average speed of vehicles in traffic in proximity to the target vehicle (e.g., additional vehicles 512 of FIG. 5) are travelling at a speed that is greater than or equal to a predetermined threshold, based on information provided by the sensors at 606 and/or other sources at 610 (e.g., traffic reports).

In one embodiment, if it is determined at 636 that the traffic is moving at a sufficient speed, then it is determined at the above-referenced 630 that the target vehicle is double parked. Similar to the discussion above, instructions are provided at 632 for movement of the vehicle 10 around the target vehicle, the instructions are implemented at 634, and the process then returns to the above-referenced 606.

Conversely, if it is determined at 636 that traffic is not moving at a sufficient speed (or, in some embodiments, that there is no moving traffic at all), then a determination is made at 638 as to whether the target vehicle is stopped at a red light (e.g., as part of traffic light 510 of FIG. 5). In various embodiments, the processor 422 of FIG. 4 makes this determination based on information provided by the sensors (e.g., cameras 415 and/or lidar 417) at 606.

In one embodiment, if it is determined at 638 that the target vehicle is stopped at a red light, then it is determined at 640 that the target vehicle is not double parked. In certain embodiments, this determination is made by the processor 422 of FIG. 4. In addition, because the target vehicle is not deemed to be double parked, there is no change at 642 as to the current path and travel procedure for the vehicle 10. Also in certain embodiments, the process returns to 620 for further monitoring.

Conversely, if it is determined at 638 that the target vehicle is not stopped at a red light, then a determination is made at 644 as to whether the target vehicle is stopped at a stop sign. In various embodiments, the processor 422 of FIG. 4 makes this determination based on information provided by the sensors (e.g., cameras 415 and/or lidar 417) at 606.

In one embodiment, if it is determined at 644 that the target vehicle is stopped at a stop sign, then it is determined at the above-referenced 640 that the target vehicle is not double parked. As discussed above, in certain embodiments, this determination is made by the processor 422 of FIG. 4. Also as discussed above, because the target vehicle is not deemed to be double parked, there is no change at 642 as to the current path and travel procedure for the vehicle 10, and the process returns to 620 for further monitoring.

Conversely, if it is determined at 644 that the target vehicle is not stopped at a stop sign, then a determination is made at 646 as to whether the target vehicle is stopped behind another vehicle. In various embodiments, the processor 422 of FIG. 4 makes this determination based on information provided by the sensors (e.g., cameras 415 and/or lidar 417) at 606. In certain embodiments, the target vehicle (e.g., vehicle 506 of FIG. 5) is deemed to be stopped behind another vehicle (e.g., vehicle 508 of FIG. 5) if the other vehicle is disposed substantially in front of the target vehicle. In certain other embodiments, the target vehicle (e.g., vehicle 506 of FIG. 5) is deemed to be stopped behind another vehicle (e.g., vehicle 508 of FIG. 5) if the other vehicle is disposed such that it would block forward movement of the target vehicle.

In one embodiment, if it is determined at 646 that the target vehicle is stopped behind another vehicle, then it is determined at the above-referenced 640 that the target vehicle is not double parked. As discussed above, in certain embodiments, this determination is made by the processor 422 of FIG. 4. Also as discussed above, because the target vehicle is not deemed to be double parked, there is no change at 642 as to the current path and travel procedure for the vehicle 10, and the process returns to 620 for further monitoring.

Conversely, if it is determined at 646 that the target vehicle is not stopped behind another vehicle, then a determination is made at 648 as to whether the target vehicle has recently moved. In various embodiments, the processor 422 of FIG. 4 makes this determination based on information provided by the sensors (e.g., cameras 415 and/or lidar 417) at 606, after the data has been filtered at 626 (e.g., by taking a number of consecutive data points in time with respect to movement of the target vehicle). In certain embodiments, the target vehicle (e.g., vehicle 506 of FIG. 5) is deemed to have been moving recently if the target vehicle has moved within the past few minutes, although this may vary in different embodiments.

In one embodiment, if it is determined at 648 that the target vehicle has recently moved, then it is determined at the above-referenced 640 that the target vehicle is not double parked. As discussed above, in certain embodiments, this determination is made by the processor 422 of FIG. 4. Also as discussed above, because the target vehicle is not deemed to be double parked, there is no change at 642 as to the current path and travel procedure for the vehicle 10, and the process returns to 620 for further monitoring.

Conversely, in one embodiment, if it is determined at 648 that the target vehicle has not recently moved, then it is instead determined at the above-referenced 630 that the target vehicle is double parked. Per the discussion above, in certain embodiments, the processor 422 of FIG. 4 makes the determination that the target vehicle is double parked at 630 and provides instructions at 632 for movement of the vehicle 10 around the target vehicle. Also per the discussion above, in certain embodiments, the steering system 24 of FIG. 1 implements the maneuver instructions at 634, and the process then proceeds to the above-reference 606.

Accordingly, as depicted in FIG. 6 and discussed above in connection therewith, in certain embodiments a decision tree is utilized, using 628-648, in determining whether the target vehicle is double parked. It will be appreciated that this may vary in certain embodiments. For example, in certain embodiments, a combination of the various factors discussed above (e.g., hazard lights, traffic flow, red light, stop sign, stopping behind another vehicle, and/or recent movement of the target vehicle) (e.g., in some embodiments, all of these factors) may be utilized together in calculating a score that may indicate a likelihood that the target vehicle is double parked, among other possible variations.

In various embodiments, the disclosed methods and systems provide for maneuvering an autonomous vehicle around a double parked target vehicle. For example, in various embodiments, the maneuvering of the autonomous vehicle around a stationary vehicle is based on a determination as to whether the stationary vehicle is double parked, which in turn is based upon various initial determinations pertaining to the stationary vehicle (including, in various embodiments, whether the target vehicle has hazard lights on, as well as whether the target vehicle is stopped at a traffic light or stop sign, whether the target vehicle is stopped behind another vehicle, and whether or not the target vehicle has recently moved).

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method for controlling movement of an autonomous vehicle around a stationary vehicle, the method comprising:
obtaining data, via one or more sensors, pertaining to the stationary vehicle;
making a plurality of initial determinations pertaining to the stationary vehicle, via a processor, based on the data;
determining whether the stationary vehicle is double parked, via the processor, based on the plurality of initial determinations; and
facilitating movement of the autonomous vehicle around the stationary vehicle, via instructions provided by the processor, if it is determined that the stationary vehicle is double parked.

2. The method of claim 1, wherein:
the making of the plurality of initial determinations includes determining whether hazard lights for the stationary vehicle are turned on; and
the determining of whether the stationary vehicle is double parked is based at least in part on whether the hazard lights are turned on.

3. The method of claim 1, wherein:
the making of the plurality of initial determinations includes determining whether traffic in proximity to the stationary vehicle is moving at a speed that is greater than a predetermined threshold; and
the determining of whether the stationary vehicle is double parked is based at least in part on whether the traffic is moving at a speed that is greater than the predetermined threshold.

4. The method of claim 1, wherein:
the making of the plurality of initial determinations includes determining whether the stationary vehicle is stopped at a red light; and
the determining of whether the stationary vehicle is double parked is based at least in part on whether the stationary vehicle is stopped at a red light.

5. The method of claim 1, wherein:
the making of the plurality of initial determinations includes determining whether the stationary vehicle is stopped at a stop sign; and
the determining of whether the stationary vehicle is double parked is based at least in part on whether the stationary vehicle is stopped at a stop sign.

6. The method of claim 1, wherein:
the making of the plurality of initial determinations includes determining whether the stationary vehicle is disposed behind another vehicle; and
the determining of whether the stationary vehicle is double parked is based at least in part on whether the stationary vehicle is disposed behind another vehicle.

7. The method of claim 1, wherein:
the making of the plurality of initial determinations includes determining whether the stationary vehicle has recently moved within a predetermined amount of time; and
the determining of whether the stationary vehicle is double parked is based at least in part on whether the stationary vehicle has moved within the predetermined amount of time.

8. The method of claim 1, wherein:
the making of the plurality of initial determinations includes:
determining whether hazard lights for the stationary vehicle are turned on; and
determining whether traffic in proximity to the stationary vehicle is moving at a speed that is greater than a predetermined threshold; and
the determining of whether the stationary vehicle is double parked comprises determining that the stationary vehicle is double parked if the hazard lights are on, the traffic is moving at a speed that is greater than the predetermined threshold, or both.

9. The method of claim 1, wherein:
the making of the plurality of initial determinations includes:
determining whether the stationary vehicle is stopped at a red light;
determining whether the stationary vehicle is stopped at a stop sign; and
determining whether the stationary vehicle is disposed behind another vehicle; and
the determining of whether the stationary vehicle is double parked comprises determining that the stationary vehicle is not double parked if any one or more of the following criteria are satisfied, namely: that the stationary vehicle is stopped at a red light, the stationary vehicle is stopped at a stop sign, or the stationary vehicle is stopped behind another vehicle.

10. The method of claim 7, wherein:
the stationary vehicle is determined to be double parked if the stationary vehicle has not moved within the predetermined amount of time; and
the stationary vehicle is determined to be double parked if the stationary vehicle has not moved within the predetermined amount of time.

11. A system for controlling movement of an autonomous vehicle around a stationary vehicle, the system comprising:
a double park object module configured to at least facilitate obtaining data pertaining to the stationary vehicle; and
a double park determination module including a processor, and configured to at least facilitate:
making a plurality of initial determinations pertaining to the stationary vehicle, based on the data;
determining whether the stationary vehicle is double parked, based on the plurality of initial determinations; and
facilitating movement of the autonomous vehicle around the stationary vehicle, if it is determined that the stationary vehicle is double parked.

12. The system of claim 11, wherein the double park determination module is configured to at least facilitate:
determining whether hazard lights for the stationary vehicle are turned on; and
determining whether the stationary vehicle is double parked based at least in part on whether the hazard lights are turned on.

13. The system of claim 11, wherein the double park determination module is configured to at least facilitate:
determining whether traffic in proximity to the stationary vehicle is moving at a speed that is greater than a predetermined threshold; and
determining whether the stationary vehicle is double parked based at least in part on whether the traffic is moving at a speed that is greater than the predetermined threshold.

14. The system of claim 11, wherein the double park determination module is configured to at least facilitate:
determining whether the stationary vehicle is stopped at a red light; and
determining whether the stationary vehicle is double parked based at least in part on whether the stationary vehicle is stopped at a red light.

15. The system of claim 11, wherein the double park determination module is configured to at least facilitate:
determining whether the stationary vehicle is stopped at a stop sign; and
determining whether the stationary vehicle is double parked based at least in part on whether the stationary vehicle is stopped at a stop sign.

16. The system of claim 11, wherein the double park determination module is configured to at least facilitate:
determining whether the stationary vehicle is disposed behind another vehicle; and
determining whether the stationary vehicle is double parked based at least in part on whether the stationary vehicle is disposed behind another vehicle.

17. The system of claim 11, wherein the double park determination module is configured to at least facilitate:
determining whether the stationary vehicle has recently moved within a predetermined amount of time; and
determining whether the stationary vehicle is double parked based at least in part on whether the stationary vehicle has moved within the predetermined amount of time.

18. The system of claim 11, wherein the double park determination module is configured to at least facilitate:
determining whether hazard lights for the stationary vehicle are turned on;
determining whether traffic in proximity to the stationary vehicle is moving at a speed that is greater than a predetermined threshold; and
determining that the stationary vehicle is double parked if the hazard lights are on, the traffic is moving at a speed that is greater than the predetermined threshold, or both.

19. The system of claim 11, wherein the double park determination module is configured to at least facilitate:
determining whether the stationary vehicle is stopped at a red light;
determining whether the stationary vehicle is stopped at a stop sign;
determining whether the stationary vehicle is disposed behind another vehicle; and
determining that the stationary vehicle is not double parked if any one or more of the following criteria are satisfied, namely: that the stationary vehicle is stopped at a red light, the stationary vehicle is stopped at a stop sign, or the stationary vehicle is stopped behind another vehicle.

20. An autonomous vehicle comprising:
a plurality of sensors configured to at least facilitate obtaining data pertaining to a stationary vehicle that is disposed in proximity to the autonomous vehicle; and
a steering system; and
a processor that is configured to at least facilitate:
making a plurality of initial determinations pertaining to the stationary vehicle, based on the data;
determining whether the stationary vehicle is double parked, based on the plurality of initial determinations; and
facilitating movement of the autonomous vehicle around the stationary vehicle, via instructions provided from the processor to the steering system, if it is determined that the stationary vehicle is double parked.
